(19) United States
(12) Patent Application Publication
(10) Pub. No.: US 2024/0017394 A1
(43) Pub. Date: Jan. 18, 2024

(54) ACTIVE SHOOTER RESPONSE ROBOT

(71) Applicants: David Lee Kennedy, II, Volant, PA (US); Benjamin Perry Ridenbaugh, Volant, PA (US)

(72) Inventors: David Lee Kennedy, II, Volant, PA (US); Benjamin Perry Ridenbaugh, Volant, PA (US)

(21) Appl. No.: 18/346,408

(22) Filed: Jul. 3, 2023

Related U.S. Application Data
(60) Provisional application No. 63/368,295, filed on Jul. 13, 2022.

(51) Int. Cl. B25J 5/00; F41H 5/14; B25J 19/02; B25J 11/00

(52) U.S. Cl. CPC B25J 5/005; F41H 5/14; B25J 19/023; B25J 11/002

(57) ABSTRACT

An active shooter response robot enabling real-time audio and video data collection and additional functionality for the application threat-elimination tactics, including negotiations, against an active shooter. The active shooter response robot is unmanned and non-autonomous as it is controlled remotely by a human operator. The active shooter response robot provides a bullet-proof compartment for storing offensive deterrence and equipment that can be brought to bear during an active shooting situation.

### CROSS-REFERENCE TO RELATED APPLICATION

This application claims the benefit of priority of U.S. provisional application No. 63/368,295, filed Jul. 13, 2022, the contents of which are herein incorporated by reference.

### BACKGROUND OF THE INVENTION

The present invention relates to active shooter response systems and, more particularly, a tracked remote-controlled robot for stopping active shooters.

Mass shootings across the world are becoming more prevalent. These shootings normally happen inside a building or through multiple buildings like a school, university, shopping mall, workplace, or other similar settings. At the present time, there is no apparent solution to this problem, only handwringing.

As can be seen, there is a need for a tracked remote-controlled robot for stopping active shooters, wherein the robot is configured to provide accurate video and audio data in real-time to an approved viewing list as well as the pertinent authorities.

### SUMMARY OF THE INVENTION

The robot embodied in the present invention can be deployed within seconds of a threat. It is operated via remote control by a trained user. The unit is capable of streaming video and audio information to preselected users as well as the appropriate authorities.

The active shooter response robot has the capability of two-way communication with multiple users and authorities. The robot has high-intensity LED lighting which can blind a threat. The unit also features several high-intensity LED strobe lights which can disorient a threat.

Armor plating is used in areas of the robot to lessen the chance of the robot being disabled by a threat firing upon it. There is a high-powered siren system that can be used to distract and intimidate a threat as well as a high-powered audio system that is used for the one-way and two-way talk operation.

A method of using the robot contemplates using the present invention as a decoy to entice a threat to fire upon the robot thus potentially saving lives.

The robot is configured to travel at speeds up to six miles per hour which will allow it to reach a threat and capture/relay information in a timely manner that can save lives.

In one aspect of the present invention, a unmanned, non-autonomous response robot includes the following: a frame defining a bullet-proof compartment storing a wireless router having antennas protruding outside of the frame; two track assemblies operatively associated with the frame; a video capture device enabled with 360-degrees visibility capturing video input that is disseminated in real-time through the wireless router; and a remote control operatively associated with the two track assemblies.

In another aspect of the present invention, the unmanned, non-autonomous response robot further includes the following: an audio transducer and speaker disposed in the bullet-proof compartment, wherein the audio transducer and speaker enable negotiations through the remote control; an audio system, a motor-speed controller, a video-data communication system, a power source and a motor disposed in the bullet-proof compartment; a top plate of the frame providing a mounting grid; and a lighting system disposed in the bullet-proof compartment, wherein the lighting system provides a strobe light element and a blinding light element, wherein the blinding light element provides a unit of luminous flux up to 200 lumens.

In yet another aspect of the present invention, a method for negotiating with an active shooter, the method includes the following: providing the above-mentioned unmanned, non-autonomous response robot; providing an operator with the remote control; moving, by way of the remote control, the unmanned, non-autonomous response robot to intercept the active shooter; and conducting negotiations between a negotiator and the active shooter by way of the audio transducer, the audio speaker, and the communication system.

These and other features, aspects and advantages of the present invention will become better understood with reference to the following drawings, description, and claims.

### BRIEF DESCRIPTION OF THE DRAWINGS

FIG. 1 is a front perspective view of an exemplary embodiment of the present invention.

FIG. 2 is a rear perspective view of an exemplary embodiment of the present invention.

FIG. 3 is a top plan schematic view of an interior compartment of an exemplary embodiment of the present invention.

FIG. 4A is a perspective view of an exemplary embodiment of a remote-control transceiver 24A of the present invention.

FIG. 4B is a perspective schematic illustration of an active shooter situation showing the present invention in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an active shooter response robot enabling real-time audio and video data collection and additional functionality for the application threat-elimination tactics, including negotiations, against an active shooter. The active shooter response robot is unmanned and non-autonomous by being controlled remotely. The active shooter response robot provides a bullet-proof compartment for storing offensive deterrence and equipment that can be brought to bear during an active shooting situation.

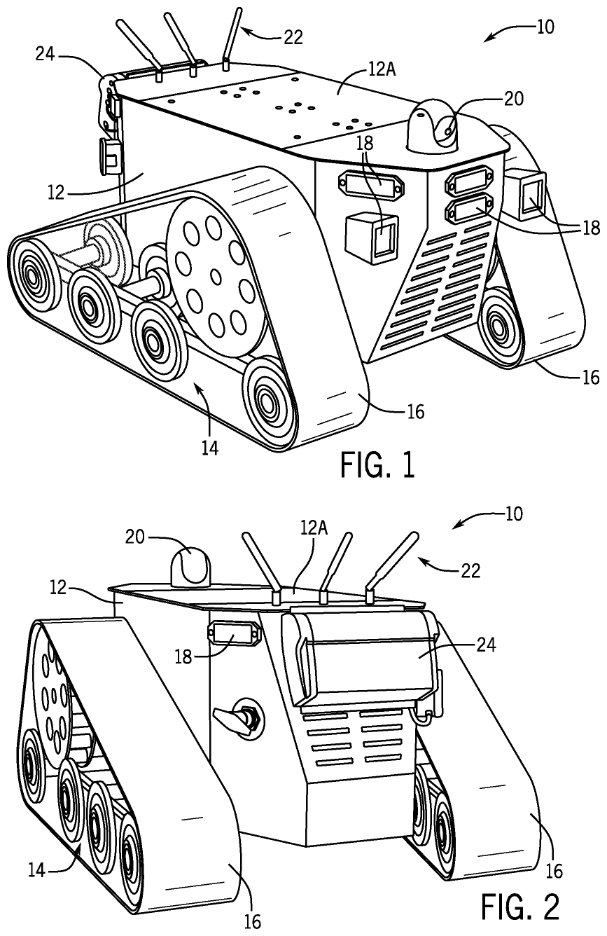

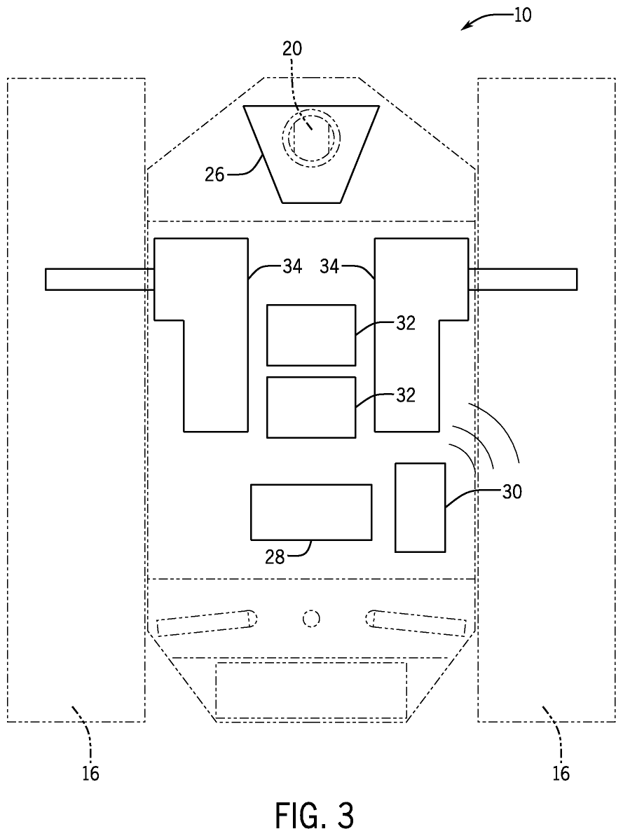

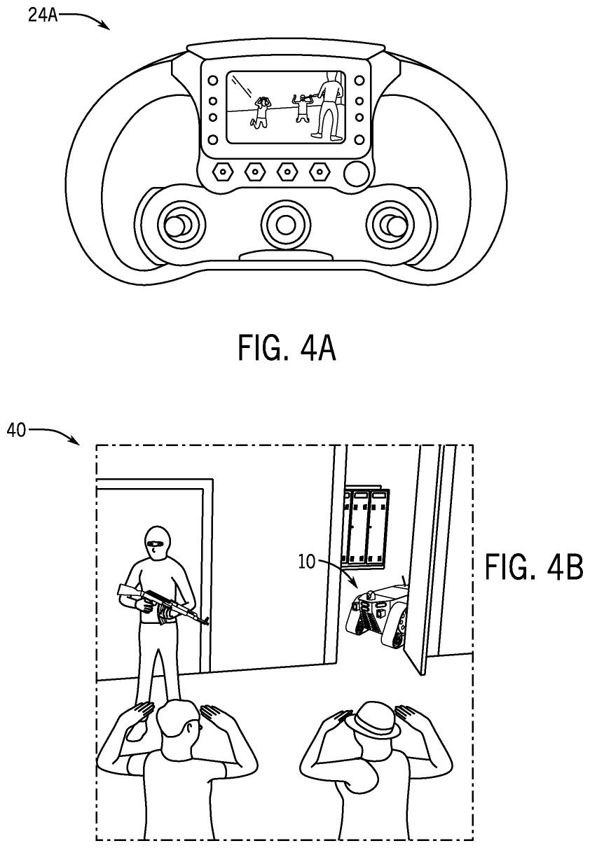

Referring now to FIGS. 1 through 4B, the present invention may include an active shooter response robot 10. The active shooter response robot 10 has a bullet-proof frame 12 including a top plate 12A with a mounting grid. The frame mounting grid may be the mainframe that most of the parts connect to.

The bullet-proof frame 12 houses a drive train assembly 14 operatively associated with a motive source for the track assemblies 16. The drive train assembly 14 wheels, axles, bushings, bearings, and the like. The track assemblies 16 may include rubber tracks that interface with the drive sprockets for imparting the unit its linear motion (as well as providing angular motion by way of the steering systems that allows the continuous track vehicle to speed one track assembly 16 up, while slowing the other down or reversing it, or a combination of both). The track assemblies 16 may be associated with idler wheels attached to the mainframe rails using heavy-duty hardware and bolts. The motive source may include one or more motors that power the main track drive system.

Along a front portion of the active shooter response robot 10 may be a strobe light 18, a video capture device 20, and a WIFI router 22. The WIFI router 22 may provide a panel-mounted extension for mounting to the frame 12 and so shielded in thick steel. There are remote panel-mounted antennas that output signals without exposing the router itself to any outside elements.

The bullet-proof frame 12 may house an onboard battery charger 24, an audio system 26, a motor-speed controller 28, a video-data communication system 30, battery 32 (e.g., 12 Volt AGM 50 mAh Batteries), and motor 34, which may include 24-volt high torque right-angle gearmotors. The active shooter response robot 10 may include a receiver as well as wiring/relays/fuses/connectors.

The video-data communication system 30 may be configured to interpret inputs from the user via a remote-control transceiver 24A and outputs amperage and voltage to the motors, lights, and sirens of the robot appropriately. The video-data communication system 30 may be a module that receives the signals from the remote-control transceiver 24A and relays them to the audio system 26, the strobe light 18, and the video capture device 20.

The audio system 26 may be 12-volt audio amplifier or the like that is operatively associated to a public announcement speaker for outputs the user's voice at a very loud amplitude. The wiring connecting all the systems and the fuses may be adapted to protect the wiring should there be a short in the system from being fired upon.

The video capture device 20 may be a 1080 HD camera or the like, that features infrared night vision and adapted to rotate 360 degrees around and 180 degrees forward to backward as well as providing pan and tilt functionality. The video capture device 20 may be equipped with a microphone which, when combined with the amplified speaker, enables remote, two-way communication with a threat or threats.

The handheld remote-control device 24A may have a screen interface in which all the communication may be handled. The handheld device 24A includes a transceiver configured to send and receive commands and data from/to the robot. It is the main wireless control interface from user to the robot.

The robot must be operated by a trained individual. As soon as a location, such as a school, university, shopping mall, airport, or similar place would go into lockdown, the active shooter response robot 10 would be deployed. As soon as the robot is deployed it begins streaming audio and video, both in high definition, to anyone on an approved list of recipients, such the trained individual and related teammates, and the owner of the structure under an active shooter situation. This list would include school officials and faculty but also the pertinent authorities.

As the robot sends real-time data to these individuals, decisions can be made based on the details and situational awareness of the threat or threats. For example, if the building is two levels and each level is scanned but only one male active shooter threat is found at a certain end of the building on the second floor, administrators and other individuals watching the stream can potentially and safely evacuate the whole entire bottom floor because of the real-time data that everyone now has access to. Furthermore, a trained and qualified police negotiator can speak through the robot's PA system to the threat while viewing the threat, and the threat can also speak back to the negotiator through the robot in real-time.

Research of the inventors has shown that someone engaging in an active shooter scenario as a threat is obviously not in their right state of mind so the additional minutes or seconds that a police negotiator can keep them occupied could be the difference between saving a life or not. The qualified operator of the robot can utilize the amplified public announce system, the high amplitude police-style sirens, the police-style red and blue strobe lights, as well as the high intensity lighting system, and/or LED fog lights to deter the threat. The high intensity lighting system may be configured to produce over 200 lumens in broad daylight to induce temporary flash blindness to an active shooter.

The robot weighs approximately 350 pounds and has a travel speed of faster than what an average human being can walk. The robot can be armed with optional offensive deterrence such as a pepper spray system, a pepper ball launcher, a rubber bullet launcher, and an electrical taser system to help incapacitate a threat. The robot features AR 500 steel which armors all the vulnerable mechanical points and makes the unit bulletproof. The weight distribution of the robot also allows it to climb most steps very easily.

A method of manufacturing may include the following. A manufacturer would start by designing the unit in computer-aided drafting. Once a design has been finalized for the prototype the parts are cut out on a steel cutting CNC plasma table and welded together at very specific tolerances. Those welded parts make up the mainframe along with some square steel tubing. That mainframe would then be powder coated and baked in an oven. The wheels, bushings, bearings, and other hardware would be installed along with the track drive sprocket and rubber track. Next, a manufacturer would wire up the motor speed controller as well as mount the track drive motors. The manufacturer would next install the batteries, charging system, Wi-Fi antennas, Wi-Fi router, and other miscellaneous electrical connectors and fuses. The manufacturer may want to install and configure the camera into the top front side of the robot. Next, the manufacturer may mount and wire up all the strobe and fog lights as well as the siren and public announce amplifier. Finally, you would install the mainframe universal top plate which acts as a lid to the top of the robot.

All elements that were previously listed may be necessary for operation. This robot may have optional offensive capabilities that could be installed which would hypothetically make it better depending on the situation. Some of those offensive capabilities would include a pepper spray system, a pepper ball launcher, a rubber bullet launcher, and an electrical taser system which would all be used to attack and stop an active shooter threat.

A method of using the present invention may include the following. The active shooter response robot 10 disclosed above may be provided. A user may be trained by the inventive entity and authorized by the location that owns the robot. That individual will be required to pass an examination both written and an in-person operations test. This individual would need to be able to operate the robot when a location went into a lockdown. It is crucial that the robot operator understands the functions and limitations of the robot to effectively relay critical audio and video data to all parties on the approved viewing list as well as the pertinent authorities. The robot is not autonomous therefore the trained operator and their utilization of the remote-control transceiver 24A is critical. The location that utilizes the robot will always ensure that there is adequate coverage with qualified and trained individuals always on-site when an active shooter situation may occur.

Additionally, future expansions might allow the robot to be operated by artificial intelligence or an array of sensors and location data. Also, the present invention can produce high-definition audio and video of an active shooter threat. This footage can be archived and or owned by the location that possesses the robot. This footage has its own intellectual property value because, depending on the situation that occurs, it may be useful in further product development, operator training, or tactics management.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. An unmanned, non-autonomous response robot comprising:
a frame defining a bullet-proof compartment storing a wireless router having antennas protruding outside of the frame;
two track assemblies operatively associated with the frame;
a video capture device enabled with 360-degrees visibility capturing video input that is disseminated in real-time through the wireless router; and
a remote control operatively associated with the two track assemblies.

2. The unmanned, non-autonomous response robot of claim 1, further comprising an audio transducer and speaker disposed in the bullet-proof compartment, wherein the audio transducer and speaker enable negotiations through the remote control.

3. The unmanned, non-autonomous response robot of claim 2, further comprising an audio system, a motor-speed controller, a video-data communication system, a power source and a motor disposed in the bullet-proof compartment.

4. The unmanned, non-autonomous response robot of claim 3, further comprising a top plate of the frame providing a mounting grid.

5. The unmanned, non-autonomous response robot of claim 4, further comprising a lighting system disposed in the bullet-proof compartment, wherein the lighting system provides a strobe light element and a blinding light element, wherein the blinding light element provides a unit of luminous flux up to 200 lumens.

6. A method for negotiating with an active shooter, the method comprising:
providing an unmanned, non-autonomous response robot of claim 3;
providing an operator with the remote control;
moving, by way of the remote control, the unmanned, non-autonomous response robot to intercept the active shooter; and
conducting a negotiation between a negotiator and the active shooter by way of the audio transducer, the audio speaker, and the communication system.
